(19) United States
(12) Patent Application Publication
(10) Pub. No.: US 2024/0044659 A1
(43) Pub. Date: Feb. 8, 2024

(54) ROUTE GENERATION APPARATUS FOR A VEHICLE AND A METHOD THEREOF

(71) Applicants: HYUNDAI MOTOR COMPANY, Seoul (KR); KIA CORPORATION, Seoul (KR)

(72) Inventor: Jong Ho Park, Incheon (KR)

(73) Assignees: HYUNDAI MOTOR COMPANY, Seoul (KR); KIA CORPORATION, Seoul (KR)

(21) Appl. No.: 18/124,991

(22) Filed: Mar. 22, 2023

(30) Foreign Application Priority Data
Aug. 4, 2022 (KR) 10-2022-0097465

(51) Int. Cl. G01C 21/34

(52) U.S. Cl. CPC G01C 21/3484; G01C 21/3407

(57) ABSTRACT

A route generation apparatus for a vehicle includes: a communication device configured to receive default route generation variables from one or more terminals of one or more users; a route generator configured to generate at least one of a first default route for a first user, a second default route for a second user, or a combination thereof, based on the default route generation variables; and a route integration device configured to integrate the first default route with the second default route to generate an autonomous driving route based on the default route generation variables.

### CROSS-REFERENCE TO RELATED APPLICATION

This application claims the benefit of and priority to Korean Patent Application No. 10-2022-0097465, filed in the Korean Intellectual Property Office on Aug. 4, 2022, the entire contents of which are incorporated herein by reference.

### TECHNICAL FIELD

The present disclosure relates to an apparatus and a method for generating a route of an autonomous vehicle based on information entered by a user.

### BACKGROUND

It is important for an autonomous vehicle where several users with different starting points or destinations are able to ride or where goods are able to be loaded to generate an efficient route.

An existing technology for generation of a route of the autonomous vehicle allows the autonomous vehicle to drive along a route specified by the user without determining a route. It is difficult for a user who wants a similar route to use the existing technology because the existing technology generates a route for a first passenger.

In the above existing technology, a waiting time becomes long because the autonomous vehicle is able to initiate driving for a new user only when the driving of the autonomous vehicle currently is in progress ends.

The existing technology considering only a starting point, a destination, and an estimated time taken for driving degrades the satisfaction of users because of reflecting various elements such as costs and passengers.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides a route generation apparatus for a vehicle for generating a two-dimensional (2D) route map and a three-dimensional (3D) route map for several users to generate various autonomous driving routes and a method thereof.

Another aspect of the present disclosure provides a route generation apparatus for a vehicle for integrating several default routes for several users to efficiently operate limited autonomous vehicles and a method thereof.

Another aspect of the present disclosure provides a route generation apparatus for a vehicle for allowing a user to enter a starting point tolerance, a departure time tolerance, a destination tolerance, or an arrival time tolerance as well as a starting point, a departure time, a destination, and an arrival time such that several users may reasonably use autonomous vehicles and a method thereof.

Another aspect of the present disclosure provides a route generation apparatus for a vehicle for generating fare discount information or penalty information based on a driving history of a user, to improve the quality of a sharing service and a method thereof.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a route generation apparatus for a vehicle may include: a communication device that receives default route generation variables from one or more terminals of one or more users; a route generator that generates at least one of a first default route for a first user, a second default route for a second user, or a combination thereof, based on the default route generation variables; and a route integration device that integrates the first default route with the second default route to generate an autonomous driving route based on the default route generation variables.

In an embodiment, the default route generation variables may include at least one of a starting point, a destination, a departure time, an arrival time, a starting point tolerance, a destination tolerance, a departure time tolerance, an arrival time tolerance, or a combination thereof entered by each of the one or more users.

In an embodiment, the route generator may be configured to generate an estimated time of arrival for each point on a default route and may generate a three-dimensional (3D) route map having the estimated time of arrival for each point as a new axis based on the default route. The route integration device may generate the autonomous driving route based on the 3D route map.

In an embodiment, the route integration device may be configured to integrate the first default route with the second default route to generate the autonomous driving route i) when a starting point and a destination of the first default route are included in the second default route or ii) when the destination of the first default route is included in the second default route and a starting point of the second default route is included in the first default route.

In an embodiment, the route integration device may be configured to integrate the first default route with the second default route to generate the autonomous driving route i) when a starting point and a destination of the first default route are adjacent to the second default route, ii) when the destination of the first default route is adjacent to the second default route and a starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route.

In an embodiment, the route generator may further be configured to generate a third default route for a third user. The route integration device may integrate the third default route with the first default route and the second default route when the third default route includes a riding point and an alighting point included in each of the first default route and the second default route.

In an embodiment, the communication device may be configured to receive route correction acceptance of integration of default routes from the terminal of the user. The route integration device may be configured to integrate the default routes to include a starting point or a destination of a user in response to the user accepting route correction in a default route of another user.

In an embodiment, the route generation apparatus may further include a history management device configured to generate at least one of credit information for a user, penalty point information for the user, or a combination thereof based on a driving history of the user, and to i) generate fare discount information for the user based on the credit information or ii) generate penalty information for the user based on the penalty point information.

In an embodiment, the history management device may be configured to generate the at least one of the credit information, the penalty point information, or the combination thereof based on at least one of whether the user complies with regulations, a review from another user, whether the user accepts route correction, whether the user delays an arrival time, a route similarity with another user, or a combination thereof.

In an embodiment, the history management device may be configured to i) calculate a distance between a starting point of the first default route and the second default route and a distance between a destination of the first default route and the second default route or ii) calculate the distance between the starting point of the first default route and the second default route and a distance between the first default route and a destination of the second default route to calculate a similarity between the first default route and the second default route.

According to another aspect of the present disclosure, a route generation method for a vehicle may include: receiving, by a communication device, default route generation variables from one or more terminals of one or more users; generating, by a route generator, at least one of a first default route for a first user, a second default route for a second user, or a combination thereof, based on the default route generation variables; and integrating, by a route integration device, the first default route with the second default route to generate an autonomous driving route based on the default route generation variables.

In an embodiment, the default route generation variables may include at least one of a starting point, a destination, a departure time, an arrival time, a starting point tolerance, a destination tolerance, a departure time tolerance, an arrival time tolerance, or a combination thereof entered by each of the one or more users.

In an embodiment, generating the at least one of the first default route, the second default route, or the combination thereof may include generating, by the route generator, an estimated time of arrival for each point on a default route and generating, by the route generator, a 3D route map having the estimated time of arrival for each point as a new axis based on the default route. Generating the autonomous driving route may include generating, by the route integration device, the autonomous driving route based on the 3D route map.

In an embodiment, generating the autonomous driving route may include integrating, by the route integration device, the first default route with the second default route to generate the autonomous driving route i) when a starting point and a destination of the first default route are included in the second default route or ii) when the destination of the first default route is included in the second default route and a starting point of the second default route is included in the first default route.

In an embodiment, generating the autonomous driving route may include integrating, by the route integration device, the first default route with the second default route to generate the autonomous driving route i) when a starting point and a destination of the first default route are adjacent to the second default route, ii) when the destination of the first default route is adjacent to the second default route and a starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route.

In an embodiment, the route generation method may further include generating, by the route generator, a third default route for a third user. The route generation method may also include integrating, by the route integration device, the third default route with the first default route and the second default route when the third default route includes a riding point and an alighting point included in each of the first default route and the second default route.

In an embodiment, the route generation method may further include receiving, by the communication device, route correction acceptance of integration of default routes from a terminal of a user among the one or more terminals of the one or more users. The route generation method may also include integrating, by the route integration device, the default routes to include a starting point or a destination of the user in response to the user accepting route correction in a default route of another user.

In an embodiment, the route generation method may further include generating, by a history management device, at least one of credit information for a user, penalty point information for a user, or a combination thereof, based on a driving history of the user. The route generation method may also include i) generating, by the history management device, fare discount information for the user based on the credit information or ii) generating, by the history management device, penalty information for the user based on the penalty point information.

In an embodiment, generating the at least one of the credit information, the penalty point information, or the combination thereof may include generating, by the history management device, the at least one of the credit information, the penalty point information, or the combination thereof, based on at least one of whether the user complies with regulations, a review from another user, whether the user accepts route correction, whether the user delays an arrival time, a route similarity with another user, or a combination thereof.

In an embodiment, the route generation method may further include i) calculating, by the history management device, a distance between a starting point of the first default route and the second default route and a distance between a destination of the first default route and the second default route or ii) calculating, by the history management device, the distance between the starting point of the first default route and the second default route and a distance between the first default route and a destination of the second default route to calculate a similarity between the first default route and the second default route.

### BRIEF DESCRIPTION OF THE DRAWINGS

The above and other objects, features, and advantages of the present disclosure may be more apparent from the following detailed description taken in conjunction with the accompanying drawings, in which:

FIG. 1 is a block diagram illustrating a route generation apparatus for a vehicle according to an embodiment of the present disclosure;

FIG. 2 is a drawing illustrating an example of generating one or more default routes depending on a starting point tolerance, a destination tolerance, and the like in a route generation apparatus for a vehicle and a method thereof according to embodiments of the present disclosure;

FIG. 3 is a drawing illustrating an example of generating a 2D route map and a 3D route map in a route generation apparatus for a vehicle and a method thereof according to embodiments of the present disclosure;

FIG. 4 is a drawing illustrating an example of integrating several default routes in a route generation apparatus for a vehicle and a method thereof according to embodiments of the present disclosure;

FIG. 5 is a drawing illustrating an example of a terminal of a user according to an embodiment of the present disclosure;

FIG. 6 is a drawing illustrating an example where a user uses a route generation apparatus for a vehicle and a method thereof according to another embodiment of the present disclosure; and

FIG. 7 is a drawing illustrating an example where a user uses a route generation apparatus for a vehicle and a method thereof according to another embodiment of the present disclosure; and

FIG. 8 is a flowchart illustrating a route generation method for a vehicle according to an embodiment of the present disclosure.

### DETAILED DESCRIPTION

Hereinafter, embodiments of the present disclosure are described in detail with reference to the accompanying drawings. In the accompanying drawings, the identical or equivalent component is designated by the identical numeral even when they are displayed on different drawings. Further, in describing the embodiments of the present disclosure, if it is considered that a specific description of related known configuration or function may cloud the gist of the present disclosure, a detailed description thereof may have been omitted.

In describing the components of the embodiments according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

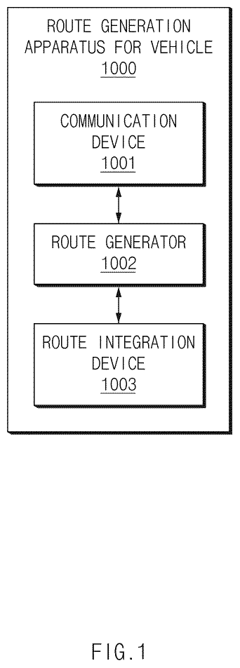

Hereinafter, embodiments of the present disclosure are described in detail with reference to FIGS. 1-8. When a component, device, element, or the like of the present disclosure is described as having a purpose or performing an operation, function, or the like, the component, device, or element should be considered herein as being “configured to” meet that purpose or perform that operation or function.

FIG. 1 is a block diagram illustrating a route generation apparatus 1000 for a vehicle according to an embodiment of the present disclosure.

In various embodiments, a vehicle according to embodiments may include, but is not limited to, one of an electric vehicle (EV), a hybrid electric vehicle (HEV), a hydrogen electric vehicle, a plug-in hybrid electric vehicle (PHEV), or an internal combustion engine vehicle.

In an embodiment, a vehicle that may utilize the route generation apparatus 1000 for a vehicle and the method thereof may be an autonomous vehicle. A passenger or an owner of goods may move from a starting point to a destination or may transport goods using the route generation apparatus 1000 for a vehicle and the method thereof according to embodiments. A transportation company or a distribution company may carry out the business of transporting passengers or goods using the route generation apparatus 1000 for a vehicle and the method thereof according to embodiments. A vehicle manufacturing company, a vehicle component manufacturing company, or a vehicle-related application development company may produce or use the route generation apparatus 1000 for a vehicle and the method thereof according to embodiments.

Referring to FIG. 1, the route generation apparatus 1000 for a vehicle according to an embodiment of the present disclosure may include a communication device 1001, a route generator 1002, and a route integration device 1003.

In some embodiments, the route generation apparatus 1000 for a vehicle according to an embodiment of the present disclosure may include one or more elements which are not illustrated in FIG. 1.

The communication device 1001 of the route generation apparatus 1000 may use a communication scheme such as, but not limited to, a local interconnect network (LIN), a controller area network (CAN), a FlexRay communication bus, media oriented systems transport (MOST), dedicated short range communication (DSRC), cellular vehicle-to-everything (C-V2X), Wi-Fi, wireless broadband (WiBro), or worldwide interoperability for microwave access (WiMAX).

The communication device 1001 may be configured to receive default route generation variables from terminals of one or more users.

In various examples, a user may be a vehicle owner, a goods owner, a passenger, a transportation company, a distribution company, or a vehicle manufacturing company.

In various examples, a terminal of the user may be a smartphone, a computer, or a server.

The default route generation variables may include at least one of a starting point, a destination, a departure time, an arrival time, a starting point tolerance, a destination tolerance, a departure time tolerance, an arrival time tolerance, or a combination thereof entered by each of the one or more users.

The starting point may include a point to start when a passenger is transported or when a goods owner delivers goods. The destination may include a point to which the passenger arrives or to which the goods arrive. The starting point tolerance or the destination tolerance may include a point near a starting point or a destination allowed by the passenger or the goods owner, for example when it is difficult to start from a starting point desired by the passenger or the goods owner or arrive at a destination desired by the passenger or the goods owner due to a traffic situation, a limit to the number of autonomous vehicles, multiple users, or the like. The starting point tolerance or the destination tolerance may include a space within a distance of a certain radius around the starting point or the destination. In various examples, the certain radius may be set by the passenger, the goods owner, or the route generation apparatus 1000.

For example, in various embodiments, the route generation apparatus 1000 for a vehicle and the method thereof according to embodiments of the present disclosure may generate a default route based on the starting point tolerance or the destination tolerance when it is impossible to integrate several default routes due to the traffic situation, the limit to the number of the autonomous vehicles, the multiple users, or the like, even though the user enters the starting point and the destination. The user may directly enter a starting point tolerance and a destination tolerance.

In examples, the departure time tolerance or the arrival time tolerance may include a certain time period before and after the departure time or the departure time allowed by the passenger or the goods owner when it is difficult to depart at a departure time desired by the passenger or the goods owner or arrive at an arrival time desired by the passenger or the goods owner due to a traffic situation, a limit to the number of autonomous vehicles, the multiple users, or the like. The certain time period before and after the departure time or the arrival time may be set by the passenger, the goods owner, or the route generation apparatus 1000 and the method thereof according to embodiments.

For example, in various embodiments, the route generation apparatus 1000 for a vehicle and the method thereof according to embodiments of the present disclosure may generate a default route based on the departure time tolerance or the arrival time tolerance when it is impossible to integrate several default routes due to the traffic situation, the limit to the number of the autonomous vehicles, the use of many users, or the like, even though the user enters the departure time and the arrival time. The user may directly input a departure time tolerance and an arrival time tolerance.

Referring still to FIG. 1, the communication device 1001 may be configured to receive route correction acceptance of integration of default routes from the terminal of the user.

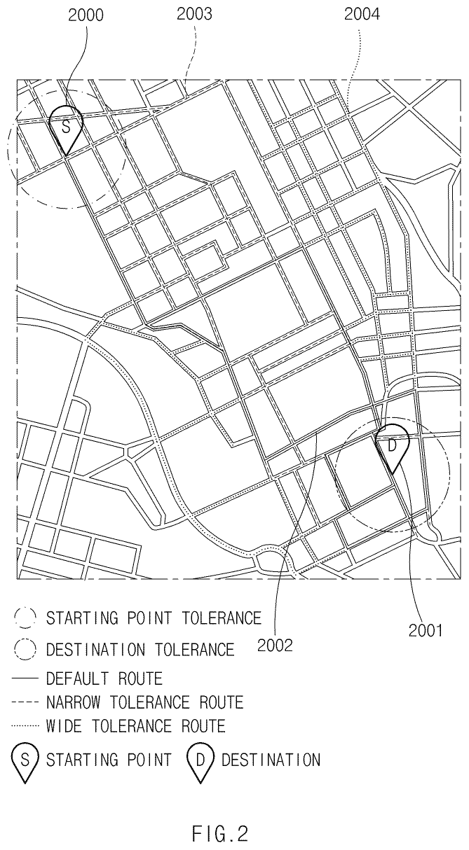

As described in more detail below with reference to FIGS. 2-4, the route generation apparatus 1000 for a vehicle and the method thereof according to embodiments of the present disclosure may generate default routes for several users and may integrate several default routes to generate an autonomous driving route. When having to correct the default route when integrating the several default routes to generate the autonomous driving route, the communication device 1001 may transmit, to the terminal of the user, a request for route correction that corrects the default route and may receive route correction acceptance from the terminal of the user.

With continued reference to FIG. 1, the route generator 1002 of the route generation apparatus 1000 may be configured to generate at least one of a first default route for a first user, a second default route for a second user, or a combination thereof, based on the default route generation variables.

The first user or the second user may include one of a passenger or a goods owner. The first user or the second user as used herein only distinguishes different persons that may use the route generation apparatus 1000 for a vehicle and the method thereof at the same time. It is not meant that the first user should use the route generation apparatus 1000 before the second user or that the first default route and the second default route should be integrated to generate an autonomous driving route with respect to the first default route.

Similarly, the first default route may be a default route for the first user, which may be distinguished from the second default route which is a default route of the second user.

The default route may include all of possible routes where the passenger or the goods arrive at a destination at an arrival time entered by the user after the passenger enters the autonomous vehicle or the goods owner loads goods on the autonomous vehicle at a starting point at a departure time entered by the user.

The route generator 1002 may generate an estimated time of arrival for each point on the default route and may generate a 3D route map that has the estimated time of arrival for each point as a new axis based on the default route.

In examples, the route generator 1002 may determine a point for the estimated time of arrival for each point on the default route per node through which the default route passes.

An example 3D route map that has the estimated time of arrival for each point as a new axis according to an embodiment is described in more detail below.

Referring still to FIG. 1, the route integration device 1003 of the route generation apparatus 1000 may be configured to integrate the first default route with the second default route to generate an autonomous driving route based on the default route generation variables.

In an example, the route integration device 1003 may generate the autonomous driving route based on the 3D route map.

For example, i) when the starting point and the destination of the first default route are included in the second default route or ii) when the destination of the first default route is included in the second default route and the starting point of the second default route is included in the first default route, the route integration device 1003 may integrate the first default route with the second default route to generate the autonomous driving route.

As another example, i) when the starting point and the destination of the first default route is adjacent to the second default route, ii) when the destination of the first default route is adjacent to the second default route and the starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route, the route integration device 1003 may integrate the first default route with the second default route to generate the autonomous driving route.

The route integration device 1003 may integrate default routes to include a starting point or a destination of a user that accepts route correction in a default route of another user.

An example in which the route integration device 1003 integrates the default routes to generate the autonomous driving route according to an embodiment is described in more detail below with reference to FIGS. 2-4.

FIG. 2 is a drawing illustrating an example of generating one or more default routes 2002, 2003, and 2004 depending on a starting point tolerance 2000, a destination tolerance 2001, and the like in a route generation apparatus for a vehicle (e.g., 1000 of FIG. 1) and a method thereof according to embodiments of the present disclosure.

As described above with reference to FIG. 1, a route generator (e.g., 1002 of FIG. 1) may generate the one or more default routes 2002, 2003, and 2004 based on a default route generation variable.

For example, the route generator may generate the default route 2002 where a user or goods start from a starting point at a departure time and arrive at a destination at an arrival time.

The default route 2002 may refer to a route or routes that a passenger or goods may travel, which is/are most suitable for a starting point, a departure time, a destination, and an arrival time entered by the user.

The route generator may generate a narrow tolerance route 2003 where the user or goods start from a starting point tolerance 2000 at a departure time and arrive at a destination tolerance 2001 at an arrival time.

For example, a route generated such that the user or the goods start from another place, rather than a starting point, within the starting point tolerance 2000 may be a starting point to which the user or the goods may move to better fit a departure time and an arrival time entered by the user than when the user or the goods start from a starting point entered by the user.

As another example, the route generator generates a route where the user or the goods start from another place within the starting point tolerance 2000 rather than a starting point entered by the user and arrive at another place within the destination tolerance 2001 rather than a destination entered by the user. Thus, it may efficiently operate an autonomous vehicle by means of a shared ride with another user, while keeping the departure time and the arrival time of the user.

The route generator may generate a wide tolerance route 2004 in which the user or goods start from a starting point tolerance 2000 within a departure time tolerance and arrive at a destination tolerance 2001 within an arrival time tolerance.

For example, the route generator generates a route in which the user or the goods i) arrive at the destination tolerance 2001 within the arrival time tolerance and ii) depart from the starting point tolerance 2000 within the departure time tolerance, rather than generating a route suitable for a starting point, a departure time, a destination, and an arrival time entered by the user. Thus, many users may use the autonomous vehicle by integrating the generated route with a route of another user.

As such, the route generation apparatus for a vehicle and the method thereof according to embodiments of the present disclosure may expand the number of possible default routes by generating the default route based on the starting point tolerance, the departure time tolerance, the destination tolerance, and the arrival time tolerance as well as based on the starting point, the departure time, the destination, and the arrival time entered by the user and integrating the generated default route with the default route of another user. Thus, the use of the vehicle by more users is enabled.

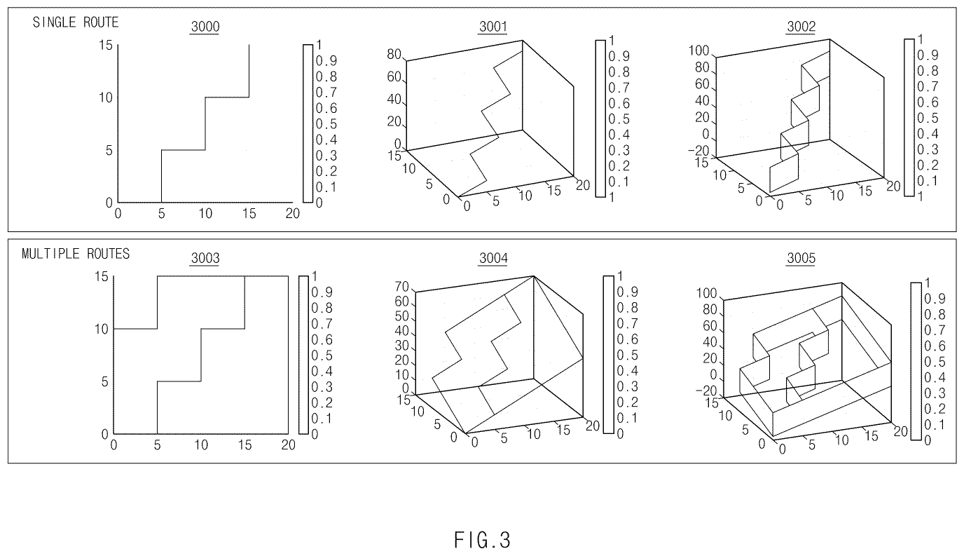

FIG. 3 is a drawing illustrating an example of generating a 2D route map and a 3D route map in a route generation apparatus for a vehicle (e.g., the route generation apparatus 1000 of FIG. 1) and a method thereof according to embodiments of the present disclosure.

A route generator (e.g., the route generator 1002 of FIG. 1) may generate an estimated time of arrival for each point on a default route and may generate a 3D route map that has the estimated time of arrival for each point as a new axis based on the default route.

A route integration device (e.g., the route integration device 1003 of FIG. 1) may generate an autonomous driving route based on the 3D route map.

FIG. 3 illustrates a 2D drawing 3000 illustrating an example of generating a single route where a user travels from a starting point entered by the user to a destination entered by the user.

A method for displaying coordinates on the 2D route map may display that (x, y)=(0, 0).

The route generator may generate an estimated time of arrival for each point on a default route.

For example, in the 2D drawing 3000, the route generator may generate an estimated time of arrival for destination (0, 5) based on a time taken to travel from starting point (0, 0) to destination (0, 5).

In the 2D drawing 3000, points (0, 5), (5, 5), (10, 5), and the like on the route may be referred to as points or nodes.

Coordinates are represented as (x, y) for better understanding in the drawing, but a person having ordinary skill in the art should understand that a 2D route map may be represented using another coordinate system, such as a coordinate system using latitude and longitude.

The route integration device may generate a 3D route map 3001 based on the 2D route map 3000 and the estimated time of arrival for each point.

In an example, a value corresponding to a z-axis added relative to the 2D route map may be an estimated time of arrival for each point.

In other words, in 3D route map 3001, an x-axis and a y-axis may be spatial coordinates corresponding to a default route on the 2D route map, and a z-axis may correspond to a temporal coordinate for an estimated time of arrival for each point.

In a 3D route map 3002, the route integration device may expand the 3D route map in the direction of the z-axis based on at least one of a departure time tolerance, an arrival time tolerance, or a combination thereof.

For example, the route integration device may expand a point corresponding to that (x, y)=(0, 0) as long as it corresponds to the departure time tolerance in the direction of the z-axis.

The route generation apparatus for a vehicle and the method thereof, according to embodiments of the present disclosure, may generate the 3D route map, thus integrating a default route of a corresponding user with a default route of another user.

Referring still to FIG. 3, an example 2D route map 3003 may be a 2D route map for multiple routes, which generates several default routes.

The illustrated example 2D route map 3003 includes a total of 3 default routes on a 2D route map. A starting point may be (0, 0), and a destination may be (20, 15).

The illustrated example 2D route map 3003 illustrates a route passing through (0, 10), a route passing through (5, 5), and a route passing through (20, 0).

The route generator may generate an estimated time of arrival for each point for a route through which each of three routes passes.

The route integration device may generate a 3D route map 3004 based on the 2D route map 3003 and the estimated time of arrival for each point.

All of routes on the 3D route map 3004 may be generated for a total of 3 routes generated on the 2D route map 3003.

Similar to 3D route map 3001, a z-axis on the 3D route map 3004 may correspond to a temporal coordinate for the estimated time of arrival for each point.

In a 3D route map 3005, the route integration device may expand the 3D route map 3004 in the direction of the z-axis based on at least one of a departure time tolerance, an arrival time tolerance, or a combination thereof.

The route generation apparatus for a vehicle and the method thereof, according to embodiments of the present disclosure, may generate a 3D route map based on the 2D route map and the estimated time of arrival even with respect to multiple routes for any starting point and any destination, thus generating various autonomous driving routes with respect to default route integration with another user.

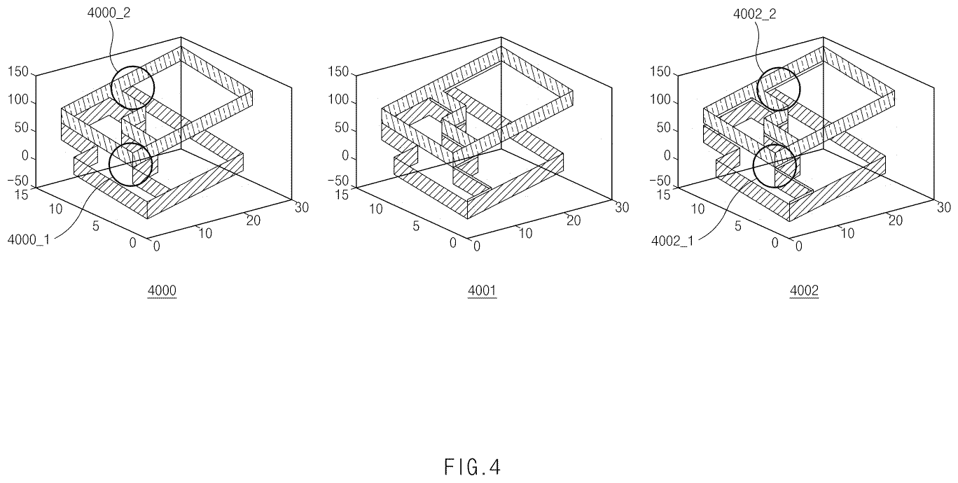

FIG. 4 is a drawing illustrating an example of integrating several default routes in a route generation apparatus for a vehicle (e.g., the route generation apparatus 1000 of FIG. 1) and a method thereof, according to embodiments of the present disclosure.

In an example, i) when the starting point and the destination of a first default route are included in a second default route or ii) when the destination of the first default route is included in the second default route and the starting point of the second default route is included in the first default route, a route integration device (e.g., the route integration device 1003 of FIG. 1) may integrate the first default route with the second default route to generate an autonomous driving route.

As described above, the first default route may be a default route for a first user, the second default route may be a default route for a second user, and the first user and the second user may be two different users.

In another example, i) when the starting point and the destination of the first default route is adjacent to the second default route, ii) when the destination of the first default route is adjacent to the second default route and the starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route, the route integration device may integrate the first default route with the second default route to generate the autonomous driving route.

Three 3D route maps 4000, 4001, and 4002 shown in FIG. 4 may be an example of illustrating 3D route maps for multiple routes of two users, which are generated according to a manner which generates the 3D route map described above with reference to FIG. 3.

As shown in FIG. 4, three default routes generated for each of two users are illustrated on the 3D route map.

For example, in the 3D route map 4000, a starting point 4000_1 of a first default route may be included in a second default route, and a destination 4000_2 of the second default route may be included in the first default route.

In this case, as illustrated in the 3D route map 4001, the route integration device may integrate the first default route with the second default route to generate an autonomous driving route, such that i) the first user starts from the starting point of the second default route and rides in an autonomous vehicle at the starting point 4000_1 of the first default route and ii) the second user alights from the autonomous vehicle at the destination 4000_2 of the second default route and arrives at the destination of the first default route.

For example, in the 3D route map 4002, the starting point 4002_1 of the first default route may be adjacent to the second default route, and the destination 4002_2 of the second default route may be adjacent to the first default route.

Determining whether the first default route is adjacent to the second default route or whether the starting point or the destination of the first default route is adjacent to the second default route may be adjusted in a manner which specifies an adjacent reference value and adds and subtracts the adjacent reference value by means of a usage pattern of the user. In an example, the adjacent reference value may be any initial value.

In this case, in the 3D route map 4002, the route integration device may integrate the first default route with the second default route to generate an autonomous driving route, such that i) the first user starts from the starting point of the second default route and rides in the autonomous vehicle at the starting point 4002_1 of the first default route adjacent to the second default route and ii) the second user alights from the autonomous vehicle at the destination 4002_2 of the second default route adjacent to the first default route and arrives at the destination of the first default route.

For example, in the 3D route map 4002, when the starting point 4002_1 of the first default route is adjacent to the second default route and when the destination 4002_2 of the second default route is adjacent to the first default, a communication device (e.g., the communication device 1001 of FIG. 1) may transmit a request for route correction to the first user, the second user, or both the first user and the second user and may receive a response to the request for the route correction from the first user and/or the second user.

For example, when both the first user and the second user accept the route correction, the route integration device may integrate the first default route with the second default route to generate an autonomous driving route based on an intermediate time between the departure time and the arrival time of the first user and the second user.

In this case, a history management device (not shown) included in the route generation apparatus for a vehicle, according to embodiments, may generate information for providing credit to the first user and the second user.

As another example, when the first user accepts the route correction, but the second user does not accept the route correction, the route integration device may correct only the first default route without correcting the second default route and may integrate the first default route with the second default route to generate an autonomous driving route.

In this case, the history management device may generate information for providing credit to only the first user.

Although an example of integrating the default routes for two users according to an embodiment is illustrated in FIG. 4, in other embodiments the route generator may generate the default route for a number of users different from two users. For example, the route generator may further generate a third default route for a third user. When the third default route includes a riding point and an alighting point included in each of the first default route and the second default route, the route integration device may integrate the third default route with the first default route and the second default route.

In an example, when it is difficult to integrate the first default route with the third default route and when it is difficult to integrate the second default route with the third default route, but when it is possible to integrate the first default route and the second default route with the third default route using a portion of the first default route and a portion of the second default route, the route integration device may include a starting point and a destination of the third user in the first default route or the second default route to add a riding point and an alighting point of the third user, when the communication device receives route correction acceptance of the third user.

As such, i) when the starting point and the destination of the first default route is adjacent to the second default route, ii) when the destination of the first default route is adjacent to the second default route and the starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route, the principle of integrating the third default route with the first default route and the second default route may be applied.

In some examples, as described above, when it is impossible to integrate the third default route with the first default route and the second default route, the communication device may transmit, to the third user, a query about whether to use the first default route, the second default route, or a portion of the first default route and the second default route and may generate an autonomous driving route for the third user to use a portion of the first default route or a portion of the second default route only with respect to some of default routes for the third user depending on a response of the third user.

As described above, information for providing credit to a user who accepts route correction or accepts a suggestion for a shared ride among the first user, the second user, or the third user or information about a discount on costs may be generated.

The examples provided above are generally described with reference to the user being a passenger. However, when the user is a goods owner (e.g., as well as a passenger), as described above, the route integration device may integrate the first default route with the second default route to generate an autonomous driving route when the goods owner loads or unloads goods at a starting point or a destination.

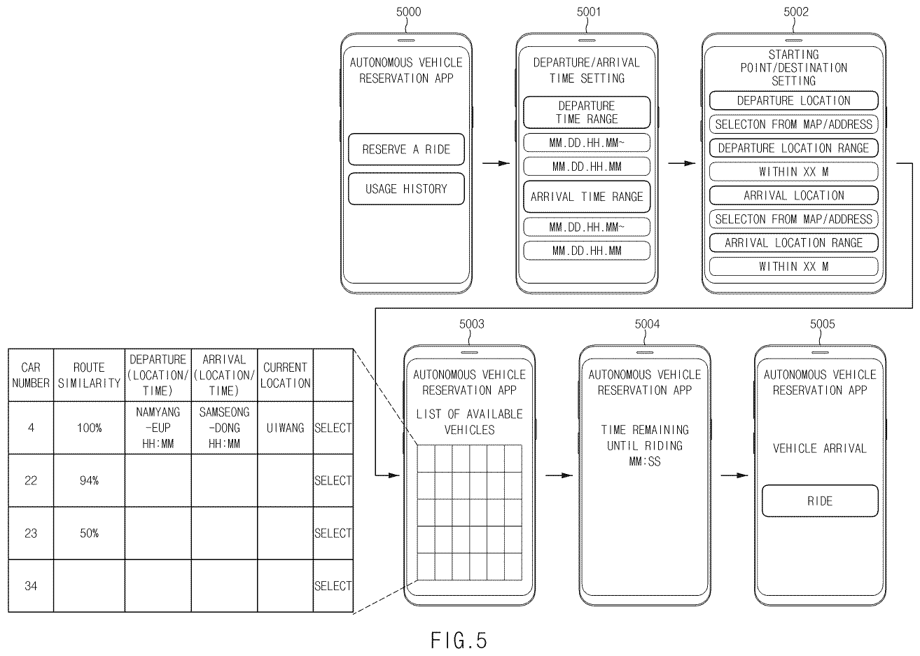

FIG. 5 is a drawing illustrating an example of a terminal of a user, according to an embodiment of the present disclosure.

In various examples, the user may be a passenger or a goods owner. In an example, the user may run an application 5000 of a smartphone to reserve riding or identify his or her usage history to use a route generation apparatus for a vehicle and a method thereof according to embodiments.

The illustrated screen of the application 5000 of the smartphone shown in FIG. 5 is an example, and the present disclosure is not limited thereto.

In an example, when the user touches a portion for reserving riding on a screen or application 5000, a screen or application 5001 for allowing the user to enter a departure time, a departure time tolerance or range, an arrival time, and an arrival time tolerance or range may be displayed.

The screen 5001 for allowing the user to enter the departure time, the departure time tolerance, the arrival time, and the arrival time tolerance is illustrative, and the present disclosure is not limited thereto.

In an example, when the user enters the departure time, the departure time tolerance or range, the arrival time, and the arrival time tolerance or range on a screen 5001, a screen 5002 for allowing the user to enter a starting point, a starting point tolerance or range, a destination, and a destination tolerance or range may be displayed.

The screen 5002 for allowing the user to enter the starting point, the starting point tolerance or range, the destination, and the destination tolerance or range is illustrative, and the present disclosure is not limited thereto.

After the user enters a starting point, a starting point tolerance, a destination, and a destination tolerance on a screen 5002, a screen for allowing the user to enter a departure time, a departure time tolerance, an arrival time, and an arrival time tolerance may be displayed or a screen for allowing the user to enter at least one of a starting point, a starting point tolerance, a destination, a destination tolerance, a departure time, a departure time tolerance, an arrival time, an arrival time tolerance, or a combination thereof may be displayed.

In an embodiment, the wider the starting point tolerance, the destination tolerance, the departure time tolerance, or the arrival time tolerance, the lower the fare may be for the user.

In an example, when the user enters what he or she needs among the starting point, the starting point tolerance, the destination, the destination tolerance, a departure time, a departure time tolerance, the arrival time, or the arrival time tolerance, a screen 5003 on which a list of information about an autonomous vehicle that is currently driving or is capable of driving in a departure time or a departure time tolerance may be displayed.

In an embodiment, a history management device may calculate a similarity between a default route for the user and a default route for another user.

For example, the history management device i) may calculate a distance between a starting point of a first default route and a second default route and a distance between a destination of the first default route and the second default route and ii) may calculate the distance the starting point of the first default route and the second default route and a distance between the first default route and a destination of the second default route to calculate a similarity between the first default route and the second default route.

In an example, an autonomous vehicle list may be sorted and displayed on a screen 5003 in an order where the similarity between the default route of the user and the default route of the other user is high.

In an example, as a default route with a lower similarity with the default route of the other user is selected, a fare may more increase.

When the user selects an autonomous vehicle, in an example, a screen 5004 for a time remaining to the riding may be displayed, but the present disclosure is not limited thereto. A screen for displaying information about a starting point at which the user will ride in the autonomous vehicle may be displayed together.

When the selected autonomous vehicle arrives at a riding point selected between the starting point or the starting point tolerance, in an example, a screen 5005 providing at least one of information about vehicle arrival, a button for allowing the user to identify riding, or a combination thereof, may be displayed.

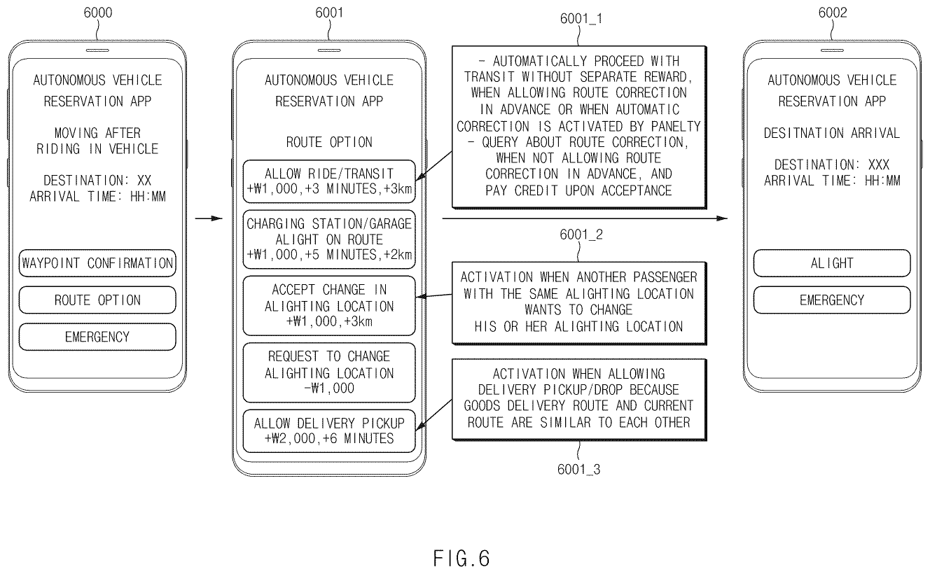

FIG. 6 is a drawing illustrating an example in which a user uses a route generation apparatus for a vehicle and a method thereof, according to another embodiment of the present disclosure.

In an example, information about waypoint confirmation, a route option, or an emergency may be displayed on a screen 6000 when the user rides in the autonomous vehicle.

In an example, by means of the waypoint confirmation, the user may identify information about a point through which he or she passes when a default route for the user is integrated with a default route for another user rather than the user to be corrected.

When the user touches the route option, in an example, information about the route option the user may select while he or she rides in the autonomous vehicle may be displayed on a screen 6001.

In an example, before the user rides in the autonomous vehicle or while the user rides in the autonomous vehicle, he or she may enter information about at least one of a usage period variable, a usage mode variable, a shared ride tolerance, a transit tolerance, a transfer tolerance, or a combination thereof.

For example, in an example, when the user allows route correction in advance, although there is no explicit acceptance of the route correction of the user, an autonomous driving route may be generated, such as is shown in 6001_1, according to the route correction. Further, information for providing credit for the user may be generated.

For another example, an autonomous driving route may be generated according to the route correction, although there is no explicit acceptance for the route correction of the user based on penalty point information.

As another example, a communication device may transmit a request for route correction for the user. An autonomous driving route may be generated according to the route correction when the user accepts the route correction. Further, information for providing credit for the user may be generated.

In an example, when another user with the same alighting or exit point is requested to change the alighting point and when the user accepts it, the autonomous driving route may be corrected according to the changed alighting point, as is shown in 6001_2. Further, information for providing credit for the accepted user may be generated.

When there is a need to load or unload a load, such as goods or food for delivery, into or from the autonomous vehicle or when there is a need to pick up or drop off a load, such as goods or food for delivery, information for providing credit information for the user may be generated, as is shown in 6001_3, when that the user accepts the stop for a load point, an unload point, a pickup point, or a drop point.

In an example, when the autonomous vehicle arrives at a destination, a screen 6002 for allowing the user to identify alighting may be displayed.

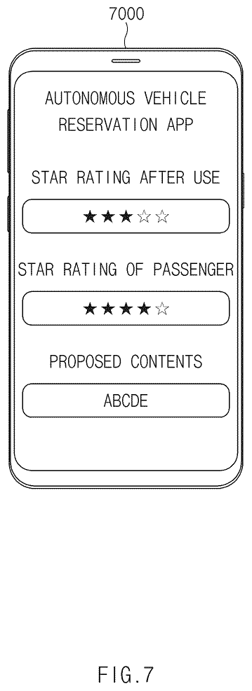

As such, a route generation apparatus for a vehicle and a method thereof according to embodiments of the present disclosure may generate an autonomous driving route by reflecting various demands of the user, may quickly select an autonomous vehicle using the route similarity, and may prepare for various situations regarding the correction of the autonomous driving route. Thus, the autonomous vehicle may be efficiently operated. FIG. 7 is a drawing illustrating an example in which a user uses a route generation apparatus for a vehicle and a method thereof according to another embodiment of the present disclosure.

In an example, a screen 7000 may be displayed where the user may select a score for corresponding driving or passenger in the form of stars after finishing using an autonomous vehicle and may leave comments regarding the service.

A history management device may generate at least one of credit information, penalty point information, or a combination thereof, based on at least one of whether the user complies with regulations, a review from another user, whether the user accepts route correction, whether the user delays an arrival time, a route similarity with another user, or a combination thereof.

For example, the history management device may generate at least one of credit information, penalty point information, or a combination thereof, for the user who is an appraisee based on a star rating for a passenger, which is left by another user.

As a more specific example, the history management device may generate credit information for a user who receive a positive review from another user and may generate penalty point information for a user who receives a negative review from another user.

As another example, the history management device may generate credit information for a user who complies with the driving regulation and may generate penalty point information for a user who does not comply with the driving regulation.

As yet another example, the history management device may generate credit information for a user who accepts route correction.

As still another example, when driving is delayed relative to an estimated time of departure or an estimated time of arrival notified to the user is performed, the history management device may generate credit information for the user.

A route generation apparatus for a vehicle and a method thereof according to embodiments of the present disclosure may perform machine learning based on information such as a time about the delayed driving and may reflect the learned result in generating a route in the future.

The history management device may generate at least one of credit information for the user, penalty point information for the user, or a combination thereof, based on a driving history of the user. The history management device i) may generate fare discount information for the user based on the credit information or ii) may generate penalty information for the user based on the penalty point information.

In an example, the user may pay for all or a portion of the fare using credit assigned to him or her and may use an autonomous vehicle using the discounted fare based on the credit information.

In another example, a route integration device may correct a default route for a user to whom a penalty point is assigned without acceptance of the user or may fail to perform route correction for the user to whom the penalty is assigned.

As such, the route generation apparatus for a vehicle and the method thereof according to embodiments of the present disclosure may generate a default route based on the driving history of the user, may integrate the generated default route with a route of another user, or fail to integrate the generated default route with a route of another user, or discount a fare. Thus, the satisfaction of the user may be maximized, and the quality of a sharing service may be improved.

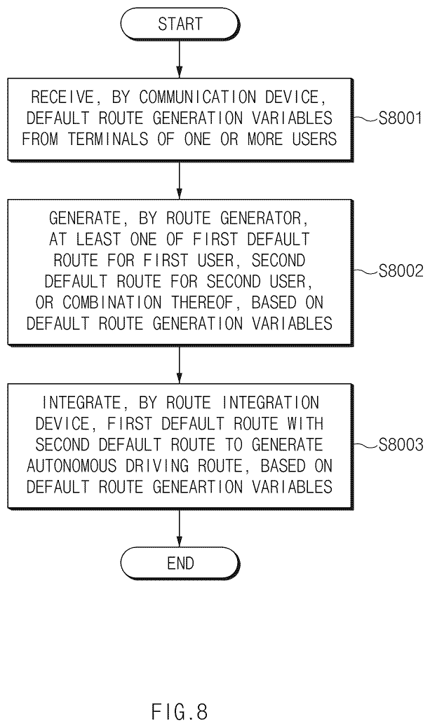

FIG. 8 is a flowchart illustrating a route generation method for a vehicle according to an embodiment of the present disclosure.

In an embodiment, a route generation apparatus for a vehicle (e.g., the route generation apparatus 1000 of FIG. 1) described above with reference to FIGS. 1-7 may perform the method described in FIG. 8.

The route generation method for a vehicle according to an embodiment of the present disclosure may include receiving (step S8001), by a communication device (e.g., the communication device 1001 of FIG. 1), default route generation variables from terminals of one or more users. The method may also include generating (step S8002), by a route generator (e.g., the route generator 1002 of FIG. 1), at least one of a first default route for a first user, a second default route for a second user, or a combination thereof, based on the default route generation variables. The method may additionally include integrating (step S8003), by a route integration device (e.g., the route integration device 1003 of FIG. 1), the first default route with the second default route to generate an autonomous driving route based on the default route generation variables.

In an embodiment, the default route generation variables may include at least one of a starting point, a destination, a departure time, an arrival time, a starting point tolerance, a destination tolerance, a departure time tolerance, an arrival time tolerance, or a combination thereof entered by each of the one or more users.

Step S8001 may be performed by the communication device described above with reference to FIGS. 1-7.

Step S8002 may be performed by the route generator described above with reference to FIGS. 1-7.

Step S8002 may include generating, by the route generator, an estimated time of arrival for each point on a default route and generating, by the route generator, a 3D route map which has the estimated time of arrival for each point as a new axis based on the default route.

Step S8003 may be performed by the route integration device described above with reference to FIGS. 1-7.

Step S8003 may include generating, by the route integration device, the autonomous driving route based on the 3D route map.

Furthermore, step S8003 may include integrating, by the route integration device, the first default route with the second default route to generate the autonomous driving route, i) when a starting point and a destination of the first default route are included in the second default route or ii) when the destination of the first default route is included in the second default route and a starting point of the second default route is included in the first default route.

Step S8003 may include integrating, by the route integration device, the first default route with the second default route to generate the autonomous driving route, i) when the starting point and the destination of the first default route are adjacent to the second default route, ii) when the destination of the first default route is adjacent to the second default route and the starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route.

In another embodiment, the route generation method for a vehicle may further include generating, by the route generator, a third default route for a third user. The route generation method may also include integrating, by the route integration device, the third default route with the first default route and the second default route when the third default route includes a riding point and an alighting point included in each of the first default route and the second default route.

The route generation method for a vehicle according to another embodiment of the present disclosure may further include receiving, by the communication device, route correction acceptance of integration of default routes from the terminal of the user. The route generation method may also include integrating, by the route integration device, the default routes to include a starting point or a destination of the user who accepts route correction in a route of another user.

The route generation method for a vehicle according to another embodiment of the present disclosure may further include generating, by a history management device, at least one of credit information for the user, penalty point information for the user, or a combination thereof, based on a driving history of the user. The route generation method may also include i) generating, by the history management device, fare discount information based on the credit information or ii) generating, by the history management device, penalty information for the user based on the penalty point information.

Generating the at least one of the credit information, the penalty point information, or the combination thereof may include generating, by the history management device, the at least one of the credit information, the penalty point information, or the combination thereof, based on at least one of whether the user complies with regulations, a review from another user, whether the user accepts route correction, whether the user delays an arrival time, a route similarity with another user, or a combination thereof.

The route generation method for a vehicle according to another embodiment of the present disclosure may further include i) calculating, by the history management device, a distance between a starting point of the first default route and the second default route and a distance between a destination of the first default route and the second default route and ii) calculating, by the history management device, the distance between the starting point of the first default route and the second default route and a distance between the first default route and a destination of the second default route to calculate a similarity between the first default route and the second default route.

An embodiment of the present disclosure may provide a route generation apparatus for a vehicle capable of generating a 2D route map and a 3D route map for several users to generate various autonomous driving routes and the method thereof.

Another embodiment of the present disclosure may provide a route generation apparatus for a vehicle for integrating several default routes for several users to efficiently operate limited autonomous vehicles and the method thereof.

Another embodiment of the present disclosure may provide a route generation apparatus for a vehicle capable of allowing the user to enter a starting point tolerance, a departure time tolerance, a destination tolerance, or an arrival time tolerance as well as a starting point, a departure time, a destination, and an arrival time such that several users may reasonably use autonomous vehicles and the method thereof.

Another embodiment of the present disclosure may provide a route generation apparatus for a vehicle for generating fare discount information or penalty information based on a driving history of the user, to improve the quality of a sharing service and the method thereof.

In addition, various effects ascertained directly or indirectly through the present disclosure may be provided.

Hereinabove, although the present disclosure has been described with reference to example embodiments and the accompanying drawings, the present disclosure is not limited thereto. The disclosed embodiments and the disclosure may be variously modified and altered by those having ordinary skill in the art to which the present disclosure pertains without departing from the spirit and scope of the present disclosure claimed in the following claims.

Therefore, embodiments of the present disclosure are provided for illustrative purposes and are not intended to limit the technical spirit of the present disclosure. The scope of the present disclosure should be construed on the basis of the accompanying claims. All the technical ideas within the scope equivalent to the claims should be included in the scope of the present disclosure.

What is claimed is:

1. A route generation apparatus for a vehicle, the route generation apparatus comprising:
a communication device configured to receive default route generation variables from one or more terminals of one or more users;
a route generator configured to generate at least one of a first default route for a first user, a second default route for a second user, or a combination thereof, based on the default route generation variables; and
a route integration device configured to integrate the first default route with the second default route, to generate an autonomous driving route based on the default route generation variables.

2. The route generation apparatus of claim 1, wherein the default route generation variables include at least one of a starting point, a destination, a departure time, an arrival time, a starting point tolerance, a destination tolerance, a departure time tolerance, an arrival time tolerance, or a combination thereof, entered by each of the one or more users.

3. The route generation apparatus of claim 1, wherein
the route generator is configured to, based on the default route, generate an estimated time of arrival for each point on a default route and generate a three-dimensional (3D) route map having the estimated time of arrival for each point as a new axis, and
the route integration device is configured to generate the autonomous driving route based on the 3D route map.

4. The route generation apparatus of claim 1, wherein the route integration device is configured to integrate the first default route with the second default route to generate the autonomous driving route i) when a starting point and a destination of the first default route are included in the second default route or ii) when the destination of the first default route is included in the second default route and a starting point of the second default route is included in the first default route.

5. The route generation apparatus of claim 1, wherein the route integration device is configured to integrate the first default route with the second default route to generate the autonomous driving route i) when a starting point and a destination of the first default route are adjacent to the second default route, ii) when the destination of the first default route is adjacent to the second default route and a starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route.

6. The route generation apparatus of claim 1, wherein
the route generator is configured to further generate a third default route for a third user, and
the route integration device is further configured to integrate the third default route with the first default route and the second default route when the third default route includes a riding point and an alighting point included in each of the first default route and the second default route.

7. The route generation apparatus of claim 1, wherein
the communication device is configured to receive route correction acceptance of integration of default routes from a terminal of a user among the one or more terminals of the one or more users, and
the route integration device is configured to integrate the default routes to include a starting point or a destination of the user in response to the user accepting route correction in a default route of another user.

8. The route generation apparatus of claim 1, further comprising a history management device configured to:
generate at least one of credit information for a user, penalty point information for the user, or a combination thereof, based on a driving history of the user, and
i) generate fare discount information for the user based on the credit information or ii) generate penalty information for the user based on the penalty point information.

9. The route generation apparatus of claim 8, wherein the history management device is configured to generate the at least one of the credit information, the penalty point information, or the combination thereof based on at least one of whether the user complies with regulations, a review from another user, whether the user accepts route correction, whether the user delays an arrival time, a route similarity with another user, or a combination thereof.

10. The route generation apparatus of claim 8, wherein the history management device is configured to i) calculate a distance between a starting point of the first default route and the second default route and a distance between a destination of the first default route and the second default route or ii) calculate the distance between the starting point of the first default route and the second default route and a distance between the first default route and a destination of the second default route to calculate a similarity between the first default route and the second default route.

11. A route generation method for a vehicle, the route generation method comprising:
receiving, by a communication device, default route generation variables from one or more terminals of one or more users;
generating, by a route generator, at least one of a first default route for a first user, a second default route for a second user, or a combination thereof, based on the default route generation variables; and
integrating, by a route integration device, the first default route with the second default route to generate an autonomous driving route based on the default route generation variables.

12. The route generation method of claim 11, wherein the default route generation variables include at least one of a starting point, a destination, a departure time, an arrival time, a starting point tolerance, a destination tolerance, a departure time tolerance, an arrival time tolerance, or a combination thereof entered by each of the one or more users.

13. The route generation method of claim 11, wherein
generating the at least one of the first default route, the second default route, or the combination thereof includes i) generating, by the route generator, an estimated time of arrival for each point on a default route and ii) generating, by the route generator, a 3D route map having the estimated time of arrival for each point as a new axis based on the default route, and
generating the autonomous driving route includes generating, by the route integration device, the autonomous driving route based on the 3D route map.

14. The route generation method of claim 11, wherein generating the autonomous driving route includes integrating, by the route integration device, the first default route with the second default route to generate the autonomous driving route, i) when a starting point and a destination of the first default route are included in the second default route or ii) when the destination of the first default route is included in the second default route and a starting point of the second default route is included in the first default route.

15. The route generation method of claim 11, wherein generating the autonomous driving route includes integrating, by the route integration device, the first default route with the second default route to generate the autonomous driving route, i) when a starting point and a destination of the first default route are adjacent to the second default route, ii) when the destination of the first default route is adjacent to the second default route and a starting point of the second default route is included in the first default route, iii) when the destination of the first default route is included in the second default route and the starting point of the second default route is adjacent to the first default route, or iv) when the destination of the first default route is adjacent to the second default route and the starting point of the second default route is adjacent to the first default route.

16. The route generation method of claim 11, further comprising:
generating, by the route generator, a third default route for a third user; and
integrating, by the route integration device, the third default route with the first default route and the second default route when the third default route includes a riding point and an alighting point included in each of the first default route and the second default route.

17. The route generation method of claim 11, further comprising:
receiving, by the communication device, route correction acceptance of integration of default routes from the terminal of the user; and
integrating, by the route integration device, the default routes to include a starting point or a destination of the user who accepts route correction in a default route of another user.

18. The route generation method of claim 11, further comprising:
generating, by a history management device, at least one of credit information for a user, penalty point information for the user, or a combination thereof, based on a driving history of the user; and
i) generating, by the history management device, fare discount information for the user based on the credit information or ii) generating, by the history management device, penalty information for the user based on the penalty point information.

19. The route generation method of claim 18, wherein generating the at least one of the credit information, the penalty point information, or the combination thereof includes generating, by the history management device, the at least one of the credit information, the penalty point information, or the combination thereof, based on at least one of whether the user complies with regulations, a review from another user, whether the user accepts route correction, whether the user delays an arrival time, a route similarity with another user, or a combination thereof.

20. The route generation method of claim 18, further comprising i) calculating, by the history management device, a distance between a starting point of the first default route and the second default route and a distance between a destination of the first default route and the second default route or ii) calculating, by the history management device, the distance between the starting point of the first default route and the second default route and a distance between the first default route and a destination of the second default route to calculate a similarity between the first default route and the second default route.
